(19) United States
(12) Patent Application Publication
(10) Pub. No.: US 2019/0262854 A1
(43) Pub. Date: Aug. 29, 2019

(54) THERMAL SPRAYING APPARATUS AND THERMAL SPRAYING SYSTEM, AND THERMAL SPRAYING TECHNIQUE THEREOF

(71) Applicant: ZYNP CORPORATION, Mengzhou, Henan (CN)

(72) Inventors: Delong XUE, Mengzhou, Henan (CN); Wuhui ZOU, Mengzhou, Henan (CN); Zengjun DANG, Mengzhou, Henan (CN); Guangdong GAO, Mengzhou, Henan (CN); Jinhui CHENG, Mengzhou, Henan (CN)

(73) Assignee: ZYNP CORPORATION, Mengzhou, Henan (CN)

(21) Appl. No.: 16/319,324

(22) PCT Filed: Apr. 5, 2017
(86) PCT No.: PCT/CN2017/079468

§ 371 Date: Jan. 19, 2019

(30) Foreign Application Priority Data
Jul. 20, 2016 (CN) 201610571824.3

(51) Int. Cl. B05B 17/04; B05B 7/16; B05B 1/24

(52) U.S. Cl. CPC B05B 17/04; C23C 4/06; B05B 1/24; B05B 7/16

(57) ABSTRACT

A thermal spraying device includes an electric arc spraying device, a rotatable worktable, spraying tools, wire placing racks and a master controller. The electric arc spraying device is arranged at a periphery of a rotatable worktable, the spraying tools are arranged on the rotatable worktable in a circumference direction, and each of the spraying tools is driven to rotate by a motor. The wire placing racks are arranged at an outside of the rotatable worktable, and each of the wire placing racks corresponds to one electric arc spraying device. The master controller is connected to the rotatable worktable to control the rotatable worktable. Compared with a handheld electric arc spraying gun, the spraying efficiency and the stability of the spraying quality are improved. A thermal spraying device having the electric arc spraying device is further provided. A thermal spraying system and a thermal spraying technology are further provided

### CROSS REFERENCE TO RELATED APPLICATIONS

The present application claims the benefit of priority to Chinese patent application No. 201610571824.3, titled “THERMAL SPRAYING DEVICE, THERMAL SPRAYING SYSTEM AND THERMAL SPRAYING TECHNOLOGY THEREOF”, filed with the Chinese State Intellectual Property Office on Jul. 20, 2016, the entire disclosure of which is incorporated herein by reference.

### BACKGROUND

Electric arc spraying is one kind of thermal spraying, and is a technology in which an electric arc between two continually feed-in metal wires is used as a heat source to melt the metal wires, the melted metal is atomized by compressed air, and atomized metal drops is accelerated to be sprayed to a workpiece to form a coating on a surface of the workpiece.

The electric arc spraying in the conventional technology uses a handheld electric arc spraying gun to manually spray a single workpiece, the working efficiency is low, the spraying quality is not steady due to human factors, and the processing cost is high.

In view of this, how to solve the problem of a low efficiency and an unsteady spraying quality of the electric arc spraying becomes an issue urgently to be solved by those skilled in the field.

### SUMMARY

In view of this, an object of the present application is to provide a thermal spraying device in order to improve the spraying efficiency and stability of the spraying quality.

Another object of the present application is to provide a thermal spraying system having the thermal spraying device in order to improve the spraying efficiency and the stability of the spraying quality.

A third object of the present application is to provide a thermal spraying technology based on the thermal spraying system in order to improve the spraying quality.

For realizing the above objects, the following technical solutions are provided according to the present application.

A thermal spraying device, including:

at least one electric arc spraying device;

a rotatable worktable, the electric arc spraying device being arranged at a periphery of the rotatable worktable;

a plurality of spraying tools arranged on the rotatable worktable in a circumference direction, each of the spraying tools being driven to rotate by a motor;

a plurality of wire placing racks arranged at outside of the rotatable worktable, each of the wire placing racks corresponding to one electric arc spraying device; and

a master controller connected to the rotatable worktable to control the rotatable worktable.

Preferably, the thermal spraying device further includes a lifting device, the electric arc spraying device is arranged on the lifting device and the master controller is connected to the lifting device to control the lifting device.

Preferably, in the thermal spraying device, the electric arc spray device includes:

a bracket;

two wire feeding mechanisms fixed on the bracket;

an insulated fixing bracket fixed on the bracket;

two contact tubes arranged on the insulated fixing bracket, wherein an included angle exists between wire feeding directions of the two contact tubes, wire outlets of the two contact tubes are close to each other, each of the contact tubes corresponds to one wire feeding mechanism, and the wire feeding mechanisms are configured to push and convey metal wires into the corresponding contact tubes;

a compressed air spray pipe fixed on the insulated fixing bracket, wherein a nozzle of the compressed air spray pipe aims at the wire outlets of the two contact tubes; and

an electric arc spray controller connected to the wire feeding mechanisms and the contact tubes to control the wire feeding mechanisms and the contact tubes.

Preferably, in the thermal spraying device, each of the wire feeding mechanisms includes:

a frame;

at least two groups of wire feeding wheel sets rotatably arranged on the frame and distributed in the wire feeding direction, wherein each group of wire feeding wheel sets includes two wire feeding wheels, wheel surfaces of the two wire feeding wheels in each group of wire feeding wheel sets are provided with grooves configured to clamp the metal wires, the two wire feeding wheels in each group of wire feeding wheel sets are engaged via gears, and the two groups of wire feeding wheel sets are both connected to the driving gear by meshing transmission; and

a power component connected to the driving gear by meshing transmission.

Preferably, in the thermal spraying device, the electric arc spraying device further includes wire guide components, each of the wire feeding mechanisms corresponds to one wire guide component, the wire guide components are arranged at an inlet side of the corresponding wire feeding mechanisms, each of the wire guide components includes two wire guide wheel sets, and position-limiting directions to the metal wires, of the two wire guide wheel sets are perpendicular to each other.

Preferably, in the thermal spraying device, the rotatable worktable includes:

a base;

a turntable horizontally arranged and rotatably connected to the base; and

a driving device connected to the turntable to drive the turntable, wherein the master controller is connected to the driving device to control the driving device.

Preferably, the thermal spraying device further includes a plurality of dust removal pipelines, the dust removal pipelines are arranged above the rotatable worktable and each dust removal pipeline corresponds to one electric arc spraying device.

Preferably, the thermal spraying device further includes a protective chamber; the electric arc spraying device, the dust removal pipeline and a part of the rotatable worktable are located inside the protective chamber; and a part of the rotatable worktable is located outside the protective chamber, the wire placing racks are arranged on an outer wall of the protective chamber, and the master controller and the electric arc spraying controller of the electric arc spraying device are located outside the protective chamber.

Preferably, the spraying tools are uniformly distributed on the rotatable worktable in the circumference direction.

Preferably, the driving device is a servo motor.

A thermal spraying system is further provided according to the present application, which includes the above thermal spraying device.

Preferably, the thermal spraying system further includes a sandblasting roughening device including:

a sand box;

a sandblasting gun connected to the sand box by a sand conveying pipe;

a compressed air device arranged between the sandblasting gun and the sand box, and configured to spray compressed air into the sandblasting gun;

a rotary table, wherein the sandblasting gun is arranged at an outside of the rotary table; and

a plurality of sandblasting tool arranged on the rotary table in a circumference direction, wherein each sandblasting tool is driven to rotate by the tool driving device, and the sandblasting gun aims at the sandblasting tools.

Preferably, in the thermal spraying system, the sandblasting roughening device further includes a sand recycling device including:

a helical sand conveying machine located below the sandblasting gun; and

a sand hoister, wherein an outlet of the helical sand conveying machine is in communication with an inlet of the sand hoister and an outlet of the sand hoister is in communication with an inlet of the sand box.

Preferably, in the thermal spraying system, the sandblasting roughening device further includes a sandblasting chamber, and the sandblasting gun, the compressed air device and the rotary table are arranged inside the sandblasting chamber.

Preferably, in the thermal spraying system, the sandblasting roughening device further includes a dust remover which is connected to the sandblasting chamber by dust removal pipelines.

Preferably, in the thermal spraying system, the sandblasting roughening device further includes a filter which is arranged between the dust removal pipelines and the dust remover.

Preferably, in the thermal spraying system, the tool driving device includes:

a tool motor;

a first friction wheel fixedly connected to a shaft of the sandblasting tool;

a friction wheel shaft transmitted and connected to the tool motor; and

a second friction wheel fixedly connected to the friction wheel shaft, wherein a wheel surface of the second friction wheel is in a frictional contact with the an edge of a plane at one side of the first friction wheel.

Preferably, in the thermal spraying system, the sandblasting roughening device further includes a blocking plate assembly fixed above a station where the sandblasting tool, which the sandblasting gun aims at, is located, and configured to block an end opening of a workpiece rotating for spraying.

A thermal spraying technology is further provided according to the present application. The thermal spraying technology is based on the thermal spraying system described above, compressed air with a pressure of 0.6 MPa is adopted and aluminum silicon wire rods with a diameter ranging from 1.6 mm to 3 mm which are melted are sprayed to the workpiece by the electric arc spraying device, the electric arc spraying device sprays the workpiece up and down repeatedly at a speed ranging from 15 mm/s to 45 mm/s, with a repetition times being one to four, and an aluminum silicon coating is formed on the surface of the workpiece.

Preferably, in the thermal spraying technology, the aluminum silicon coating has a roughness, Rz, ranging from 100 μm to 250 μm, and has a thickness ranging from 0.1 mm to 0.8 mm.

Preferably, in the thermal spraying technology, wire feeding speeds of the aluminum silicon wire rods range from 4 m/min to 8 m/min, and a voltage of the electric arc spraying device ranges from 28V to 40V.

Preferably, in the thermal spraying technology, the content of silicon in the aluminum silicon wire rods ranges from 11% to 13%.

Preferably, in the thermal spraying technology, before spraying the workpiece, the surface of the workpiece is roughened by the sandblasting roughening device, compressed air used for sandblasting has a pressure not lower than 0.6 Mpa, and a roughening time ranges from 5 seconds to 15 seconds.

Preferably, in the thermal spraying technology, a roughened portion of the workpiece which is roughened has a roughness, Rz, ranging from 30 μm to 90 μm, and has a cleanliness level of Sa 3.

Compared with the conventional technology, the present application has the following technical effects. In the thermal spraying device according to the present application, the electric arc spraying device is arranged at the periphery of a rotatable worktable, spraying tools which are driven to rotate by the motor are located on the rotatable worktable in a circumference direction and the rotatable worktable is controlled to rotate by the master controller; when a certain spraying tool rotates together with the rotatable worktable to the station where the electric arc spraying device is located, the electric arc spraying device performs a thermal spraying operation to the workpiece on the spraying tool; after that, the rotatable worktable continues to rotate and the electric arc spraying device sprays the workpiece on a next spraying tool, thereby realizing the assembly line spray. Compared with holding the electric arc spraying gun in hands in the conventional technology, the spraying efficiency is improved, manual spray is needless, and the stability of the spraying quality is improved.

### BRIEF DESCRIPTION OF THE DRAWINGS

For more clearly illustrating embodiments of the present application or the technical solution in the conventional technology, drawings used in the embodiments or the descriptions about the conventional technology are briefly introduced below. Apparently, the drawings described below are merely the embodiments of the present application, and those skilled in the art may achieve other drawings, based on these drawings, without any creative efforts.

FIG. 1 is a schematic view showing the structure of a thermal spraying device according to the present application;

FIG. 2 is a top schematic view showing the structure of an electric arc spraying device of the thermal spraying device according to the present application;

FIG. 3 is a schematic view showing the structure of FIG. 2 taken along A-A;

FIG. 4 is a schematic view showing the structure of a rotatable worktable of the thermal spraying device according to the present application;

FIG. 5 is an electrical schematic diagram of the thermal spraying device according to the present application;

FIG. 6 is a schematic view showing the structure of a sandblasting roughening device according to the present application;

FIG. 7 is a side view of the sandblasting roughening device according to the present application; and

FIG. 8 is a schematic view showing the structure of a tool driving device of the sandblasting roughening device according to the present application.

| | | | |
|---|---|---|---|
| 1 | guiding wheel set, | 2 | bracket, |
| 3 | wire feeding mechanism, | 301 | frame, |
| 302 | wire feeding wheel set, | 303 | driving gear, |
| 4 | gear motor, | 5 | insulated fixing bracket, |
| 6 | contact tube, | 7 | compressed air spray pipe, |
| 8 | electric arc spraying | | |
| | controller; | | |
| 01 | rotatable worktable, | 011 | turntable, |
| 012 | base, | 013 | driving device, |
| 014 | turntable bracket, | 02 | spraying tool, |
| 021 | motor, | 03 | dust removal pipeline, |
| 04 | protective chamber, | 05 | lifting device, |
| 06 | electric arc spraying | 07 | wire placing rack, |
| | device, | | |
| 08 | master controller; | | |
| 11 | sand box, | 12 | compressed air device, |
| 13 | partition, | 14 | sandblasting tool, |
| 141 | first friction wheel, | 15 | tool driving device, |
| 151 | tool motor, | 152 | chain, |
| 153 | friction wheel shaft, | 154 | second friction wheel, |
| 155 | telescoping mechanism, | 16 | filter, |
| 17 | dust remover, | 18 | discharged air filter, |
| 19 | sand hoister, | 110 | rotary table, |
| 1101 | rotary table shaft, | 1102 | rotary table motor, |
| 111 | sandblasting gun, | 112 | helical sand conveying machine, |
| 113 | blocking plate, | 114 | supporting frame. |

### DETAILED DESCRIPTION

A thermal spraying device is provided according to the present application, which can perform an assembly line spray operation, thus may improve the spraying efficiency and the stability of spraying quality.

A thermal spraying system including the thermal spraying device is further provided according to the present application, which can perform the assembly line spray operation, thus may improve the spraying efficiency and the stability of spraying quality.

A thermal spraying technology based on the thermal spraying system is further provided according to the present application, which may improve the spraying quality.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

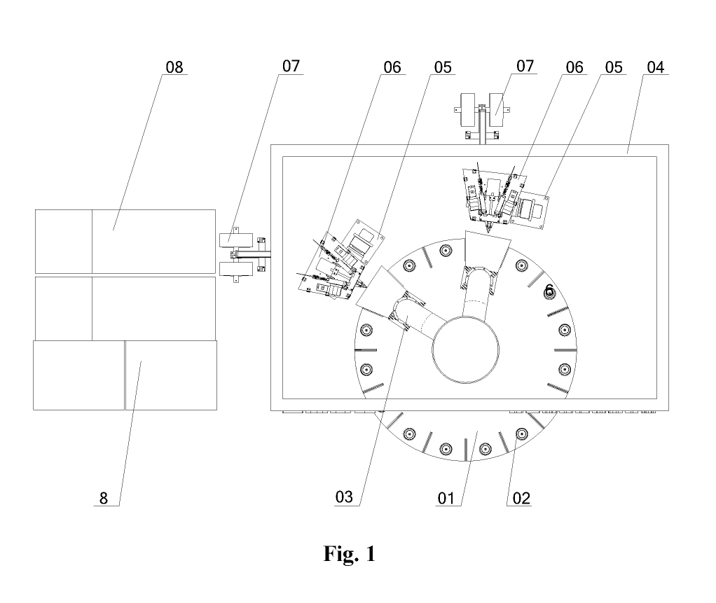

Referring to FIG. 1, a thermal spraying device is provided according to the present application, which includes at least one electric arc spraying device 06, a rotatable worktable 01, a plurality of spraying tools 02, a plurality of wire placing racks 07 and a master controller 08. The rotatable worktable 01 rotates in the horizontal plane, the electric arc spraying device 06 is arranged on a periphery station of the rotatable worktable 01, and the spraying tools 02 are arranged on the rotatable worktable 01 in the circumference direction. Preferably, the spraying tools 02 are uniformly distributed on the rotatable worktable 01 in the circumference direction and perform circling motion together with the rotatable worktable 01. Each of the spraying tools 02 is driven to rotate by a motor 021 to drive the workpiece to rotate. The wire placing racks 07 are arranged at an outside of the rotatable worktable 01, and each of the wire placing racks 07 corresponds to one electric arc spraying device 06. The wire placing racks 07 are configured to place metal wires to supply the electric arc spraying device 06 with the metal wires. The master controller 08 is connected to the rotatable worktable 01 to control the rotation of the rotatable worktable 01.

The working process of the above thermal spraying device is as follows. The electric arc spraying device 06 is arranged on the periphery station of the rotatable worktable 01, and the master controller 08 controls the rotatable worktable 01 to rotate. When the spraying tool 02 reaches the station where the electric arc spraying device 06 is located, the master controller 08 controls the rotatable worktable 01 to stop rotating, the electric arc spraying device 06 aims at the workpiece on the spraying tool 02, and at the same time the spraying tool 02 is driven to rotate by the motor 021, an electric arc spraying controller 8 controls a wire feeding mechanism 3 to feed the metal wires and controls a voltage of a contact tube 6 to melt the metal wires by electrifying, and a compressed air spray pipe 7 sprays atomized metal fine drops to a surface of the rotating workpiece. After the spraying is completed, the master controller 08 controls the rotatable worktable 01 to continue to rotate so that a next spraying tool 02 reaches the station where the electric arc spraying device 06 is located, and the spraying of a workpiece on the next spraying tool 02 is performed, and the above process cycles in turn. Therefore, the assembly line spray operation is achieved. Compared with manually performing the spraying by a handheld electric arc spraying gun in the conventional technology, the spraying efficiency is improved, the problem of unstable spraying quality due to human factor is avoided, and the stability of the spraying quality is improved.

Preferably, the number of the electric arc spraying device 06 is two, thus can spray different positions of each workpiece, which allows the spraying to be uniform.

Furthermore, in this embodiment, the thermal spraying device further includes a lifting device 05, the electric arc spraying device 06 is arranged on the lifting device 05, and the master controller 08 is connected to the lifting device 05. The lifting device 05 can rise and fall through an electric lifting cylinder, a hydraulic cylinder or a pneumatic linear actuator. The lifting device 05 is common in the market and can be directly bought to use. The purpose of setting the lifting device 05 is to control the lifting device 05 to move upward and downward by the master controller 08 when the spray operation is performed, thus the electric arc spraying device 06 is driven to move upward and downward so that the workpiece can be thoroughly and uniformly sprayed. Of course, the lifting device 05 may not provided, just the spraying is not as uniform as the spraying when the lifting device 05 is provided.

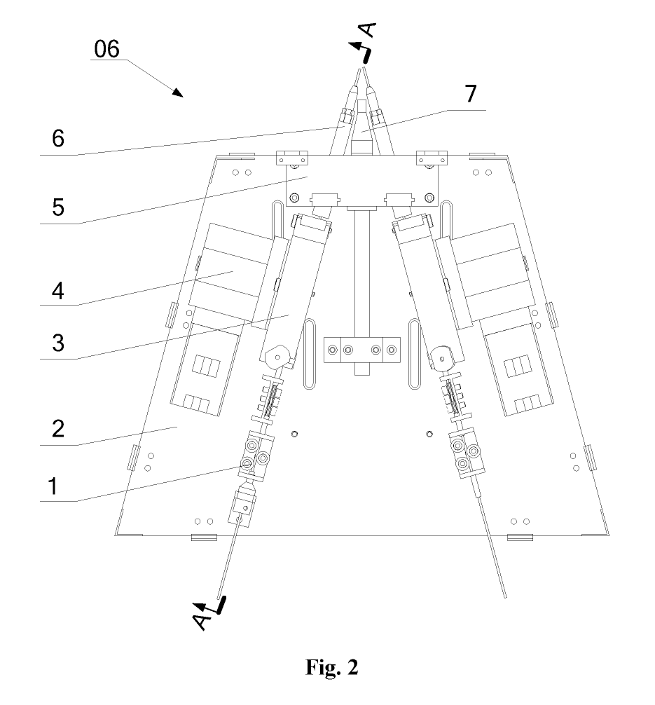

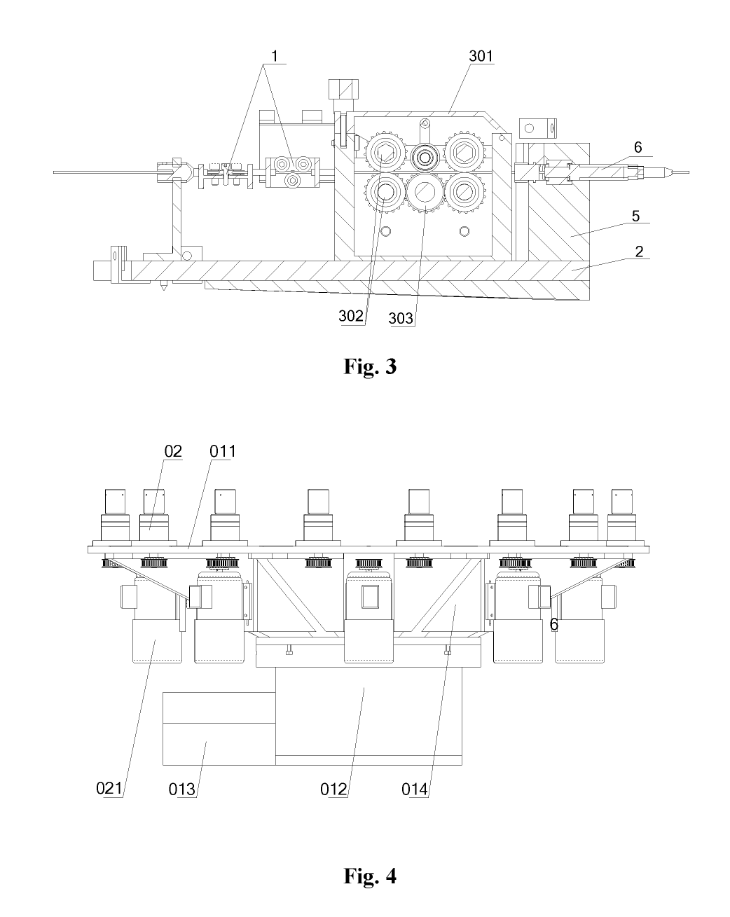

As shown in FIGS. 2 and 3, an electric arc spraying device 06 is provided according to the present application, which includes a supporting base 2, a wire feeding mechanism 3, an insulated fixing bracket 5, a contact tube 6, a compressed air spray pipe 7 and an electric arc spraying controller 8. The supporting base 2 is of a plate structure and is configured to support other components. The number of the wire feeding mechanism 3 is two and the two wire feeding mechanisms 3 are both fixed on the supporting base 2 and are configured to push and convey the metal wires into the contact tube 6. The insulated fixing bracket 5 is fixed on the supporting base 2, and located at an output side of the two wire feeding mechanisms. The number of the contact tubes 6 is two and the two contact tubes 6 are both fixed on the insulated fixing bracket 5. There is an included angle between wire feeding directions of the two contact tubes 6. Wire outlets of the two contact tubes 6 are close to each other, however are not in contact with each other, and are insulated from each other via the insulated fixing bracket 5. Each contact tube 6 corresponds to one wire feeding mechanism 3, and the two wire feeding mechanisms 3 push and convey the metal wires to the corresponding contact tubes 6. Two metal wires extend outward via the wire outlets of the two contact tubes 6 respectively. Since the two wire outlets form a certain included angle, the two metal wires keep getting close to each other until they are in contact during the extending process. The compressed air spray pipe 7 is fixed on the insulated fixing bracket 5, a nozzle of the compressed air spray pipe 7 aims at the wire outlets of the two contact tubes 6, and the compressed air spray pipe 7 is connected to a compressed air system and is configured to spray high-speed air to the wire outlets of the two contact tubes 6. The electric arc spraying controller 8 is connected to the wire feeding mechanisms 3 and the contact tubes 6, and configured to control a metal wire feeding speed of the wire feeding mechanisms 3 and the voltage of the contact tubes 6 respectively.

The working principle of the contact tubes 06 are as follows. Two metal wires are respectively conveyed into the two contact tubes 6 via two wire feeding mechanisms 3, and the two metal wires are in contact after respectively extending from the wire outlets of the contact tube 6. After the two contact tubes 6 are electrified, the two metal wires are electrically connected and are melted under the action of electricity. Compressed air is introduced into the compressed air spray pipe 7 and is sprayed to melted portions of the two metal wires via the nozzle of the compressed air spray pipe 7 to atomize the metal wires and spray atomized metal at a high speed, and the atomized metal fine drops are sprayed on the workpiece and form a metal coating, thus the electric arc spraying is completed. Since the supporting base 2, the contact tubes 6, the compressed air spray pipe 7, the wire feeding mechanisms 3 and the insulated fixing bracket 5 of the electric arc spraying device in the present application are fixed together, which as a whole can be arranged on an assembly line station and realize the assembly line spray operation. Compared with manually performing the spraying in the conventional technology by the handheld electric arc spraying gun, the spraying efficiency is improved, the problem of unstable spraying quality caused by human factor is avoided, and the stability of the spraying quality is improved.

As shown in FIGS. 2 and 3, in this embodiment, each metal wire mechanism 3 includes a frame 301, a wire feeding wheel set 302, a driving gear 303 and a power component 4. The frame 301 is fixed on the supporting base 2 and has a vertically arranged casing structure. The wire feeding wheel set 302 is rotatably arranged in the frame 301. At least two groups of the wire feeding wheel sets 302 are provided, and are arranged in the wire feeding direction. Each of the wire feeding wheel sets 302 includes two wire feeding wheels and wheel surfaces of the two wire feeding wheels in each of the wire feeding wheel sets 302 are provided with grooves matched with each other for clamping the metal wires. The two wire feeding wheels are both provided with gears, the two wire feeding wheels are engaged via the gears and both the two groups of the wire feeding wheel sets 302 are connected to the driving gear 303 by meshing transmission. Specifically, there are two groups of wire feeding wheel sets 302 and four wire feeding wheels in total. Each wire feeding wheel is provided with a gear and the driving gear 303 is provided between two groups of the wire feeding wheel sets 302 and connected to one wire feeding wheel of each group of the wire feeding wheel sets 302 by meshing transmission. The power component 4 is transmitted and connected to the driving gear 303, and the power component 4 may be a gear motor or a hydraulic motor. During operation, the power component 4 drives the driving gear 303, the driving gear 303 drives two wire feeding wheels of the two groups of the wire feeding wheel sets 302 to rotate, one wire feeding wheel in each group of the wire feeding wheel sets 302 drives another wire feeding wheel to rotate, the grooves on the wheel surfaces of the two wire feeding wheels of each group of the wire feeding wheel sets 302 clamp the metal wires and the metal wires are pushed and conveyed to the contact tube 6 with the rotation of the wire feeding wheel, and the pushing and conveying directions in the two groups of the wire feeding wheel sets 202 are identical.

Of course, the wire feeding mechanism 3 also may include one or more wire feeding wheel sets 302, as long as the pushing and conveying directions of the wire feeding wheel sets 302 are identical.

As shown in FIGS. 2 and 3, in this embodiment, the electric arc spraying device 06 further includes a wire guide component 1, and each wire feeding mechanism 3 corresponds to one wire guide component 1. The wire guide component 1 is arranged at an inlet side of the wire feeding mechanism 3, each wire guide component 1 includes two wire guide wheel sets, with limiting directions to the metal wires being perpendicular to each other. The metal wires are limited and guided by the two wire guide wheel sets having perpendicular limiting directions, thus the metal wires entering the wire feeding mechanism 3 are steadily conveyed.

As shown in FIG. 4, in this embodiment, a rotatable worktable 01 includes a base 012, a turntable 011 and a driving device 013. The base 012 is fixed and immovable, and the turntable 011 is horizontally arranged and rotatably connected to the base 012. Specifically, a turntable bracket 014 is provided between the turntable 011 and the base 012, the turntable 011 is fixedly connected to the turntable bracket 014, and the turntable bracket 014 is rotatably connected to the base 012. The spraying tool 02 is installed on the turntable bracket 014, the driving device 013 is connected to the turntable 011, and specifically may be connected to the turntable 011 by a gear train, for driving the turntable 011 to rotate relative to the base 012. The master controller 08 is connected to the driving mechanism 013, the driving mechanism 013 may be a servo motor, and the servo motor 013 is controlled to act by the master controller 08, thus the rotatable worktable 01 is controlled to rotate.

As shown in FIG. 1, in this embodiment, the thermal spraying device further includes a plurality of dust removal pipelines 03, the dust removal pipelines 03 are arranged above the rotatable worktable 01, and each of the dust removal pipelines 03 corresponds to one electric arc spraying device 06. The position of the dust removal pipeline 03 is fixed relative to the station where the electric arc spraying device 06 is located, and thus when the electric arc spraying device 06 sprays, dust and fog generated at the position of the spraying tool 02, which is spraying, are absorbed to protect the environment.

As shown in FIG. 1, the thermal spraying device further includes a protective chamber 04 which is enclosed to be a ring-shaped structure. The electric arc spraying device 06, the dust removal pipeline 03 and a part of the turntable 011 are located inside the protective chamber 04, and a part of the turntable 011 is located outside the protective chamber 04. The wire placing racks 07 are arranged on an outer wall of the protective chamber 04, and the master controller 08 and the electric arc spraying controller 8 of the electric arc spraying device 06 are located outside the protective chamber 04. The scattering of the dust and fog generated during the spraying process can be reduced by the protective effect of the protective chamber 04 and thus the working environment is further protected. Since a part of the rotatable worktable 01 is located outside the protective chamber 04, the workpiece can be installed and disassembled outside the protective chamber 04, and workers needn't to operate in the protective chamber 04, thus the safety of the workers are protected.

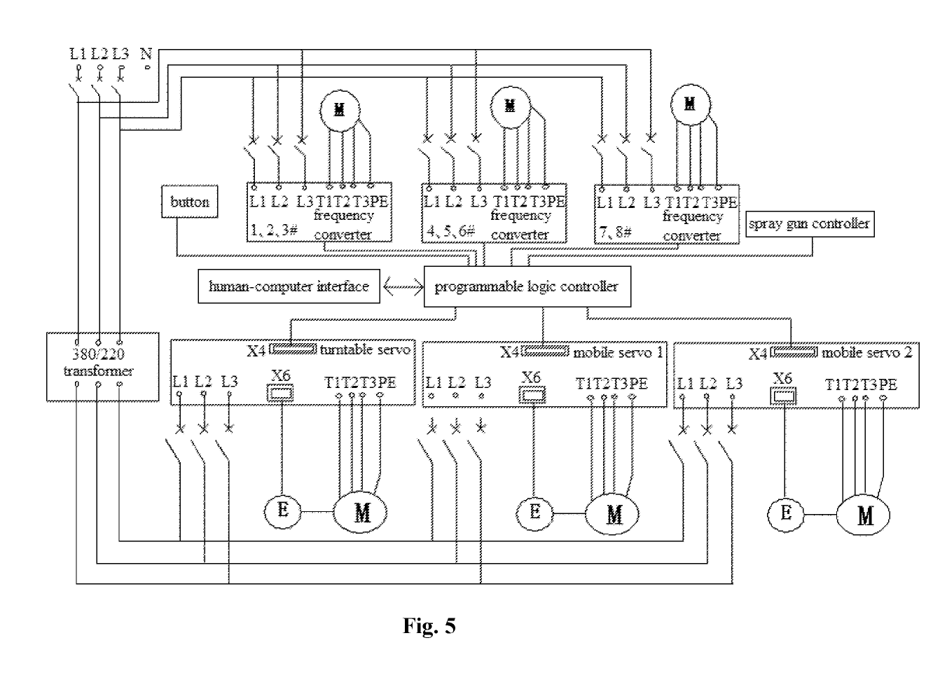

FIG. 5 is an electrical schematic diagram of the thermal spraying device according to the present application. The thermal spraying device may use Siemens S7-1200 as the controller, and of course other controllers may also be used. The input device is mainly a button and a proximity switch, and the output is mainly starting and stopping of a control frequency converter, and pulses and directions of a servo. The frequency converter and the motor 021 of the spraying tool 02 are connected with a one-to-one correspondence between them for controlling the starting and stopping of the motor 021. The controller controls the servo motor of the rotatable worktable 01 according to programs and controls the turntable 011 to stop when the turntable 011 turns to a certain position. The controller controls two servo motors of two lifting devices 05 according to programs to control the upward and downward movements of the electric arc spraying device 06, and the control principle is the same as the control principle of the servo motor of the rotatable worktable 01. When the turntable 011 rotates to a predetermined position and the servo motor of the lifting device 05 drags the electric arc spraying device 06 to move upward and downward to start spraying, the controller sends a signal to drive the motor 021 of the spraying tool 02 to rotate. A touch screen communicates with the controller S7-1200, a position of the servo motor is set in the touch screen and can be changed at any time.

A thermal spraying system is further provided according to the present application, which includes the thermal spraying device described in the above embodiments, through which the assembly line spray operation is realized. Compared with manually performing spray by handheld electric arc spraying gun in the conventional technology, the spraying efficiency is improved, the problem of spraying quality being unstable caused by human factors is avoided, and the stability of the spraying quality is improved.

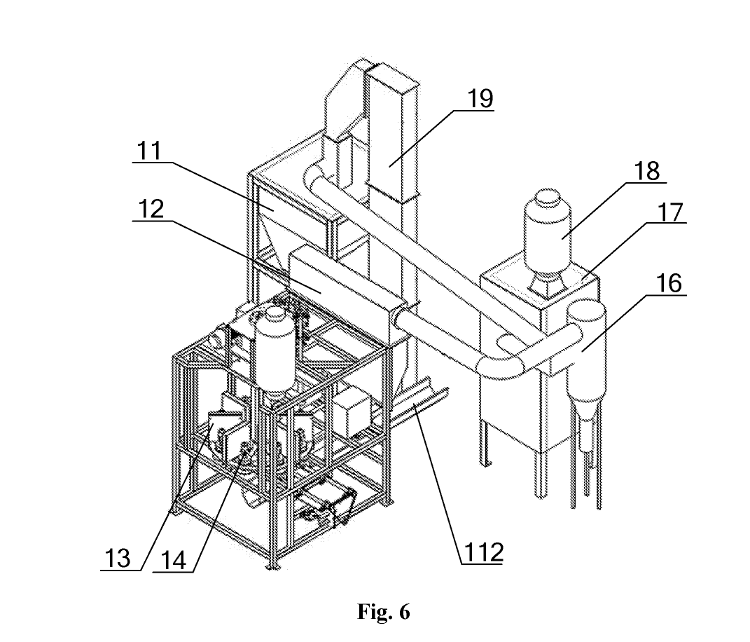

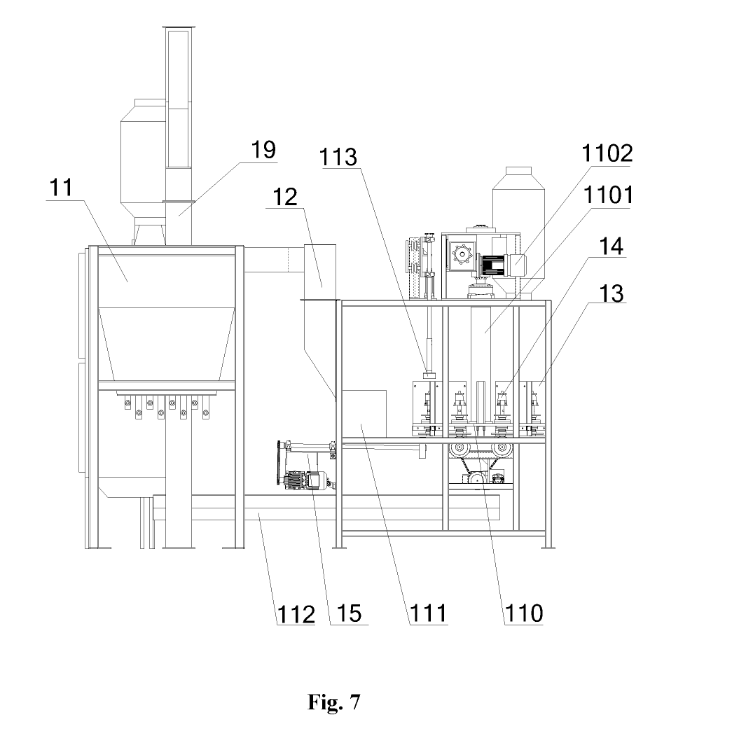

As shown in FIGS. 6 and 7, for further improving the spraying quality, the thermal spraying system in this embodiment further includes a sandblasting roughening device configured to sandblast a surface of the workpiece before spraying for roughening the surface of the workpiece, thus paint may adhere to the surface well. The sandblasting roughening device includes a sand box 11, a sandblasting gun 111, a compressed air device 12, a rotary table 110 and a plurality of sandblasting tools 14. The sand box 11 is configured to contain sandblasting materials, the sandblasting gun 111 is connected to the sand box 11, and the sand in the sand box 11 may enter the sandblasting gun 111 and finally is sprayed to the surface of the workpiece from the sandblasting gun 111. The compressed air device 12 is arranged between the sandblasting gun 111 and the sand box 11 and is configured to spray compressed air to the sandblasting gun 111, an air flow with high-speed movement forms a negative pressure in the sandblasting gun 111, and the sandblasting materials in the sand box 11 are absorbed into the sandblasting gun 111 and are sprayed out via a nozzle of the sandblasting gun 111. The rotary table 110 rotates in the horizontal plane, the sandblasting gun 111 is arranged at the station on the outer periphery of the rotary table 110, and the number of the sandblasting gun 111 may be one or more than one. The sandblasting tools 14 are arranged on the rotary table 110 in a circumference direction, each of the sandblasting tools 14 is driven to rotate by the tool driving device 15, and the sandblasting gun 111 aims at the sandblasting tool 14.

The working principle of the above sandblasting roughening device is as follows. The workpiece to be sandblasted is fixed on the sandblasting tool 14, the rotary table 110 rotates, and the sandblasting tool 14 performs a circular motion together with the rotary table 110. When a certain sandblasting tool 14 reaches the station where the sandblasting gun 111 is located, the rotary table 110 stops rotating, the sandblasting gun 111 aims at the workpiece on the sandblasting tool 14, and at the same time the sandblasting tool 14 is driven to rotate by the tool driving device 15, the compressed air device 12 sprays high-speed air flow into the sandblasting gun 111, the sand in the sand box 11 is absorbed into the sandblasting gun 111 and is sprayed to the surface of the workpiece via the nozzle of the sandblasting gun 111, and the surface of the workpiece is roughened. After the sandblasting roughening is finished, the rotary table 110 continues to rotate to allow a next sandblasting tool 14 to reach the station where the sandblasting gun 111 is located, so that the sandblasting roughening of the workpiece on the next sandblasting tool 14 is performed, and the above process sequentially and circularly proceeds. The roughened workpiece is conveyed to the thermal spraying device to perform the spraying operation, the workpiece having a roughened surface can better adhere the paint, thus the spraying quality is further improved.

As shown in FIGS. 6 and 7, for preventing the sandblasting tool 14, which is performing the sandblasting, from interfering with other sandblasting tools 14, a partition 13 is arranged between every two adjacent sandblasting tools 14 in this embodiment. The partition 13 is fixed on the rotary table 110 to isolate the sandblasting tools 14 from each other, so that the sand on the station of the sandblasting tool 14 which is performing the sandblasting may not enter other stations, thereby facilitating concentration of the sand and reducing scattering of the sand.

As shown in FIGS. 6 and 7, the sandblasting roughening device is further optimized in the embodiment. The sandblasting roughening device further includes a sand recycling device. The sand recycling device includes a helical sand conveying machine 112 and a sand hoister 19. The helical sand conveying machine 112 includes a U-shaped groove having an upward opening, and a helical conveying mechanism is arranged in the U-shaped groove. The helical sand conveying machine 112 is located under the station where the sandblasting gun 111 is located and is located below the rotary table 110 for collecting the sand sprayed from the sandblasting gun 111. The sand falls into the helical sand conveying machine 112, and is conveyed to the sand hoister 19 via the helical sand conveying mechanism. The sand hoister 19 includes a closed conveying passage which is vertically arranged, and a plurality of sand recycling boxes conveyed by chains are provided in the closed conveying passage. The plurality of sand recycling boxes are sequentially distributed in the vertical direction and circularly rise and fall with the conveying of the chains. When reaching the highest point, the sand recycling boxes overturn and the sand in the sand recycling boxes is poured out, and the sand enters the sand box 11 via an outlet of the closed conveying passage. The procedure sequentially and circularly proceeds. The used sand can be recycled, and an operating environment of the sandblasting roughening device remains clear at the same time.

Of course, the sand recycling device may have other structural styles as long as the sand can be recycled and conveyed to the sand box 11, and the structure styles are not limited to the styles listed in the embodiment. Of course, the sand recycling device may not be provided, and the sand in the sandblasting roughening device is cleaned regularly instead.

For further improving the operating environment of the sandblasting roughening device, in this embodiment, the sandblasting roughening device further includes a sandblasting chamber, which is a half closed chamber. The sandblasting gun 111, the sandblasting tool 14 and the rotary table 110 are arranged inside the sandblasting chamber, one side of the sandblasting chamber is provided with a window for installing and disassembling the workpiece, and other portions of the sandblasting chamber are all closed. Thus, the scattering to the surrounding environment of the sand sprayed by the sandblasting gun 111 is reduced and the operating environment is improved.

In this embodiment, the sandblasting roughening device further includes a dust remover 17 connected to the sandblasting chamber by the dust removal pipelines. During the working process of the sandblasting roughening device, the sand inevitably scatters in the sandblasting chamber, and the working environment is adversely affected. The dust in the sandblasting chamber is drawn into the dust remover 17 by a draught fan and the like, so that the dust is removed and after the dust is removed, the air is discharged to the outer environment, thus the operating environment is improved and protected.

Further, the sandblasting roughening device further includes a filter 16 which is arranged between the dust removal pipelines and the dust remover 17. Before the dust in the sandblasting chamber entering the dust remover 17, the dust first enters the filter 16 to be filtered, thus the dust removal effect is enhanced and the dust remover 17 is protected. A discharged air filter 18 is arranged at an outlet of the dust remover 17, thus the air discharged to the outer environment is further purified.

As shown in FIG. 7, in the embodiment, for preventing the sandblasting gun 111 from spraying the sand into the workpiece, the sandblasting roughening device further includes a blocking plate assembly fixed above the station where the sandblasting tool 14, which the sandblasting gun 111 aims at, is located. The blocking plate assembly includes a blocking plate 113, a connecting rod which is fixedly connected to the blocking plate 113, is movable upward and downward and is rotatable, and a connecting rod driving device. When a certain sandblasting tool 14 rotates together with the rotary table 110 to the station where the sandblasting gun 111 is located, the connecting rod driving device drives the connecting rod to move downward and drives the blocking plate 113 to block an opening at an upper end of the workpiece to prevent the sand from entering inside of the workpiece. Since the connecting rod is rotatable, during the process that the sandblasting tool 14 drives the workpiece to rotate, the blocking plate 113 rotates together with the workpiece and may not interfere with the rotation of the workpiece.

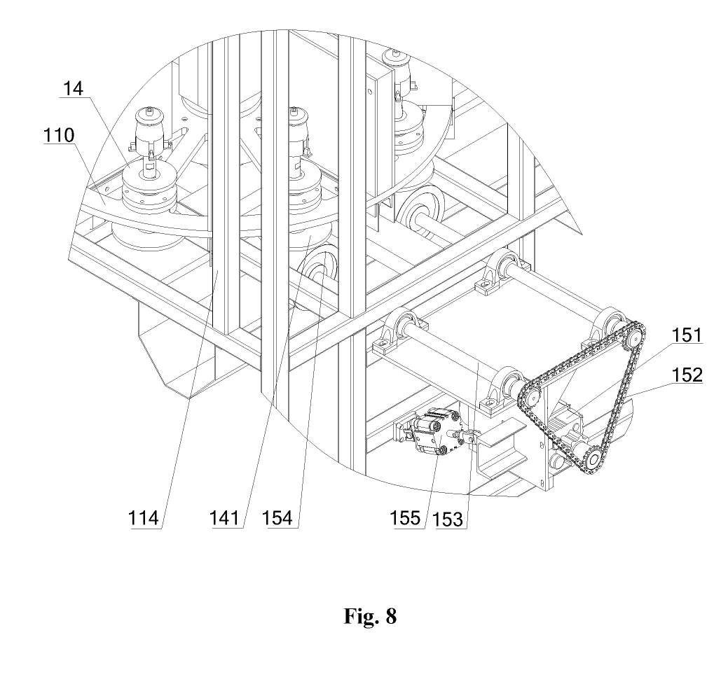

As shown in FIG. 8, a tool driving device 15 is provided according to the embodiment, which includes a tool motor 151, a friction wheel shaft 153, a first friction wheel 141, a second friction wheel 154 and a chain 152. The tool motor 151 and the friction wheel shaft 153 are transmitted and connected by the chain 152, the second friction wheel 154 is fixedly connected to the friction wheel shaft 153, and the first friction wheel 141 is connected to a rotation shaft of the sandblasting tool 14. Preferably, a rotation axis of the first friction wheel 141 is arranged to be perpendicular to a rotation axis of the second friction wheel 154. A wheel surface of the second friction wheel 154 is in a frictional contact with an edge of a plane at one side of the first friction wheel 141. The first friction wheel 141 is driven to rotate by a pivoting friction of the second friction wheel 154. The rotation shaft of each of the sandblasting tools 14 is provided with one first friction wheel 141. When a certain sandblasting tool 14 rotates together with the rotary table 110 to a station where the sandblasting gun 111 is located, the first friction wheel 141 is in a frictional contact with the second friction wheel 154 of the tool driving device 15 located on the station, the tool motor 151 works and the sandblasting tool 14 is driven to rotate. Of course, the number of the friction wheel shafts 153 is determined according to the practical needs and may be one, two, three or more than three. At least one tool driving device 15 is arranged on the station where the sandblasting tool 14 is located and the sandblasting gun 111 aims at the sandblasting tool 14, and the tool driving device 15 may also be arranged on the stations where other sandblasting tools 14 are located. The friction wheel shaft 153 may also be transmitted and connected to the tool motor 151 by gears and so on. Moreover, the tool driving device 15 may also be other forms, for example, the rotation shaft of each sandblasting tool 14 is directly transmitted and connected to one tool motor 151 as long as the sandblasting tool 14 can be driven to rotate, and the forms are not limited to the forms listed in the embodiment.

Furthermore, as shown in FIG. 8, the tool driving device 15 is rotatably connected to a supporting frame 114 of the sandblasting roughening device, the rotation axis of the tool driving device 15 is perpendicular to the axis of the friction wheel shaft 153, the friction wheel shaft 153 can rotate around the rotation axis of the tool driving device 15, thus allowing the second friction wheel 154 to get close to or be away from the first friction wheel 141. The tool driving device 15 is driven to rotate by a telescoping mechanism 155. In a case that the sandblasting tool 14 is required to be driven to rotate, the telescoping mechanism 155 acts on the tool driving device 15 and the second friction wheel 154 is raised to contact with the first friction wheel 141. In a case that the sandblasting tool 14 is not required to be driven to rotate, the telescoping mechanism 155 acts in a reverse direction and the second friction wheel 154 descends and disengages the first friction wheel 141. Of course, the telescoping mechanism 155 may not be provided, in such case, the second friction wheel 154 of the tool driving device 15 is always in contact with the first friction wheel 141, and only the rotation of the rotary table 110 is affected to a certain degree and the rotation may not smooth. The telescoping mechanism 155 may be a telescoping cylinder and so on.

As shown in FIG. 7, the rotary table 110 of the sandblasting roughening device includes a tool table, a rotary table shaft 1101 and a rotary table motor 1102. The tool table is fixedly connected to the rotary table shaft 1101, and the rotary table shaft 1101 is transmitted and connected to the rotary table motor 1102. Both the rotary table shaft 1101 and the rotary table motor 1102 are located above the tool table and the rotary table motor 1102 drives the tool table to rotate by a reduction box, a self-centering keyless bushing and the rotary table shaft 1101.

A thermal spraying technology is further provided according to the present application. The thermal spraying technology is based on the thermal spraying system described above, the specific operation is that: compressed air with a pressure of 0.6 MPa is adopted and aluminum silicon wire rods with a diameter ranging from 1.6 mm to 3 mm which are melted are sprayed to the workpiece by the electric arc spraying device, the electric arc spraying device sprays the workpiece up and down repeatedly at a speed ranging from 15 mm/s to 45 mm/s, with a repetition times being one to four, and an aluminum silicon coating is formed on the surface of the workpiece.

Further, in this embodiment, the aluminum silicon coating has a roughness, Rz, ranging from 100 μm to 250 μm, and has a thickness ranging from 0.1 mm to 0.8 mm.

In this embodiment, wire feeding speeds of the aluminum silicon wire rods range from 4 m/min to 8 m/min, and a voltage of the electric arc spraying device ranges from 28V to 40V.

Further, in this embodiment, the content of silicon in the aluminum silicon wire rods ranges from 11% to 13%.

Further, in this embodiment, before spraying the workpiece, the surface of the workpiece is roughened by the sandblasting roughening device, compressed air used for sandblasting has a pressure not lower than 0.6 Mpa, and a roughening time ranges from 5 seconds to 15 seconds.

Further, in this embodiment, a roughened portion of the workpiece which is roughened has a roughness, Rz, ranging from 30 μm to 90 μm, and has a cleanliness level of Sa3.

The above embodiments are described in a progressive manner. Each of the embodiments is mainly focused on describing its differences from other embodiments, and references may be made among these embodiments with respect to the same or similar portions among these embodiments.

Based on the above description of the above described embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A thermal spraying device, comprising:
at least one electric arc spraying device;
a rotatable worktable, the electric arc spraying device being arranged at a periphery of the rotatable worktable;
a plurality of spraying tools arranged on the rotatable worktable in a circumference direction, each of the spraying tools being driven to rotate by a motor;
a plurality of wire placing racks arranged at outside of the rotatable worktable, each of the wire placing racks corresponding to one electric arc spraying device; and
a master controller connected to the rotatable worktable to control the rotatable worktable.

2. The thermal spraying device according to claim 1, wherein the thermal spraying device further comprises a lifting device, the electric arc spraying device is arranged on the lifting device, and the master controller is connected to the lifting device to control the lifting device.

3. The thermal spraying device according to claim 1, wherein the electric arc spraying device comprises:
a supporting base;
two wire feeding mechanisms fixed on the supporting base;
an insulated fixing bracket fixed on the supporting base;
two contact tubes installed on the insulated fixing bracket, wherein an included angle exists between wire feeding directions of the two contact tubes, wire outlets of the two contact tubes are close to each other, each of the contact tubes corresponds to one wire feeding mechanism, and the wire feeding mechanisms are configured to push and convey metal wires into the corresponding contact tubes;
a compressed air spray pipe fixed on the insulated fixing bracket, wherein a nozzle of the compressed air spray pipe aims at the wire outlets of the two contact tubes; and
an electric arc spray controller connected to the wire feeding mechanisms and the contact tubes to control the wire feeding mechanisms and the contact tubes.

4. The thermal spraying device according to claim 3, wherein each of the wire feeding mechanisms comprises:
a frame;
at least two groups of wire feeding wheel sets distributed in the wire feeding direction and rotatably arranged on the frame, wherein each group of wire feeding wheel sets comprises two wire feeding wheels, wheel surfaces of the two wire feeding wheels in each group of wire feeding wheel sets are provided with grooves configured to clamp metal wires, the two wire feeding wheels in each group of wire feeding wheel sets are engaged via gears, and the two groups of wire feeding wheel sets are both connected to the driving gear by meshing transmission; and
a power component connected to the driving gear by meshing transmission.

5. The thermal spraying device according to claim 1, wherein the electric arc spraying device further comprises wire guide components, each of the wire feeding mechanisms corresponds to one wire guide component, the wire guide components are arranged at an inlet side of the corresponding wire feeding mechanisms, each of the wire guide components comprises two wire guide wheel sets, and position-limiting directions to the metal wires, of the two wire guide wheel sets are perpendicular to each other.

6. The thermal spraying device according to claim 1, wherein the rotatable worktable comprises:
a base;
a turntable horizontally arranged and rotatably connected to the base; and
a driving device connected to the turntable to drive the turntable, wherein the master controller is connected to the driving device to control the driving device.

7. The thermal spraying device according to claim 1, wherein the thermal spraying device further comprises a plurality of dust removal pipelines, the dust removal pipelines are arranged above the rotatable worktable, and each of the dust removal pipelines corresponds to one electric arc spraying device.

8. The thermal spraying device according to claim 7, further comprising a protective chamber, wherein the electric arc spraying device, the dust removal pipelines and a part of the rotatable worktable are located inside the protective chamber, a part of the rotatable worktable is located outside the protective chamber, the wire placing racks are arranged on an outer wall of the protective chamber, and the master controller and the electric arc spraying controller of the electric arc spraying device are located outside the protective chamber.

9. The thermal spraying device according to claim 1, wherein the spraying tools are uniformly distributed on the rotatable worktable in a circumference direction of the rotatable worktable.

10. The thermal spraying device according to claim 6, wherein the driving device is a servo motor.

11. A thermal spraying system, wherein the thermal spraying system comprises the thermal spraying device according to claim 1.

12. The thermal spraying system according to claim 11, further comprising a sandblasting roughening device, wherein
the sandblasting roughening device comprises:
a sand box;
a sandblasting gun connected to the sand box by a sand conveying pipe;
a compressed air device arranged between the sandblasting gun and the sand box and configured to spray compressed air into the sandblasting gun;
a rotary table, the sandblasting gun being arranged at an outside of the rotary table; and
a plurality of sandblasting tools arranged on the rotary table in a circumference direction, wherein each of the sandblasting tools is driven to rotate by the tool driving device, and the sandblasting gun aims at the sandblasting tools.

13. The thermal spraying system according to claim 12, wherein the sandblasting roughening device further comprises a sand recycling device, and the sand recycling device comprises:
a helical sand conveying machine located below the sandblasting gun; and
a sand hoister, wherein an outlet of the helical sand conveying machine is in communication with an inlet of the sand hoister, and an outlet of the sand hoister is in communication with an inlet of the sand box.

14. The thermal spraying system according to claim 12, wherein the sandblasting roughening device further comprises a sandblasting chamber, and the sandblasting gun, the compressed air device and the rotary table are all arranged inside the sandblasting chamber.

15. The thermal spraying system according to claim 14, wherein the sandblasting roughening device further comprises a dust remover connected to the sandblasting chamber by dust removal pipelines.

16. The thermal spraying system according to claim 15, wherein the sandblasting roughening device further comprises a filter arranged between the dust removal pipelines and the dust remover.

17. The thermal spraying system according to claim 12, wherein the tool driving device comprises:
a tool motor;
a first friction wheel fixedly connected to a rotation shaft of the sandblasting tool;
a friction wheel shaft connected to the tool motor by transmission; and
a second friction wheel fixedly connected to the friction wheel shaft, wherein a wheel surface of the second friction wheel is in a frictional contact with the an edge of a plane at one side of the first friction wheel.

18. The thermal spraying system according to claim 12, wherein the sandblasting roughening device further comprises a blocking plate assembly fixed above a station where the sandblasting tool, at which the sandblasting gun aims, is located, and configured to block a port of a workpiece rotating for spraying.

19. A thermal spraying technology, wherein the thermal spraying technology is based on the thermal spraying system according to claim 12, compressed air with a pressure of 0.6 MPa is adopted and aluminum silicon wire rods with a diameter ranging from 1.6 mm to 3 mm which are melted are sprayed to the workpiece by the electric arc spraying device, the electric arc spraying device sprays the workpiece up and down repeatedly at a speed ranging from 15 mm/s to 45 mm/s, with a repetition times being one to four, and an aluminum silicon coating is formed on the surface of the workpiece.

20. The thermal spraying technology according to claim 19, wherein the aluminum silicon coating has a roughness, Rz, ranging from 100 μm to 250 μm, and has a thickness ranging from 0.1 mm to 0.8 mm.

21. The thermal spraying technology according to claim 19, wherein wire feeding speeds of the aluminum silicon wire rods range from 4 m/min to 8 m/min, and a voltage of the electric arc spraying device ranges from 28V to 40V.

22. The thermal spraying technology according to claim 19, wherein the content of silicon in the aluminum silicon wire rods ranges from 11% to 13%.

23. The thermal spraying technology according to claim 19, wherein before spraying the workpiece, the surface of the workpiece is roughened by the sandblasting roughening device, compressed air used for sandblasting has a pressure not lower than 0.6 Mpa, and a roughening time ranges from 5 seconds to 15 seconds.

24. The thermal spraying technology according to claim 23, wherein a roughened portion of the workpiece which is roughened has a roughness, Rz, ranging from 30 μm to 90 μm, and has a cleanliness level of Sa 3.
